(19) United States
(12) Patent Application Publication
(10) Pub. No.: US 2015/0286170 A1
(43) Pub. Date: Oct. 8, 2015

(54) IMAGE HEATING APPARATUS

(71) Applicant: CANON KABUSHIKI KAISHA, Tokyo (JP)

(72) Inventors: Yasuharu Notoya, Tokyo (JP); Kazuhisa Kemmochi, Suntou-gun (JP); Tsutomu Miki, Komae-shi (JP); Takahiro Hosokawa, Kawasaki-shi (JP); Masaru Toda, Inagi-shi (JP); Akiko Kigure, Yokosuka-shi (JP)

(21) Appl. No.: 14/674,473

(22) Filed: Mar. 31, 2015

(30) Foreign Application Priority Data
Apr. 2, 2014 (JP) 2014-076242

(51) Int. Cl. G03G 15/20

(52) U.S. Cl. CPC G03G 15/206

(57) ABSTRACT

An image heating apparatus includes: a rotatable member configured to heat a toner image on a recording material, wherein the rotatable member includes a parting layer at a surface thereof; a heating portion configured to heat the rotatable member; a slidable member slidable on the parting layer, wherein the slidable member includes a surface layer having a surface roughness larger than a surface roughness of the parting layer; and a moving mechanism configured to move the slidable member relative to the rotatable member, which is in a rotating state, in a direction crossing with a rotational direction of the rotatable member so that a part of exfoliated matter of the parting layer and/or the surface layer is welded on the parting layer.

### FIELD OF THE INVENTION AND RELATED ART

The present invention relates to an image heating apparatus mountable in an image forming apparatus such as an electrophotographic copying machine or an electrophotographic printer.

As a fixing device (fixing apparatus) mounted in the electrophotographic copying machine or printer, in general, a fixing device of a heating roller type has been known.

The fixing device of this type includes a fixing roller, a pressing roller for forming a nip with the fixing roller, and a heater for heating the fixing roller. A recording material for carrying thereon an unfixed toner image is heated in the nip while being nipped and fed through the nip, so that the toner image is fixed on the recording material. This fixing roller had such a problem that a surface thereof is gradually roughened by damage sustained by nipping and feeding the recording material in a nip, paper powder deposited in the case where the recording material is paper, and a contaminant such as an offset toner.

A most conspicuous factor changing a surface state (shape) of the fixing roller is burrs generated at end portions during cutting of the paper.

In a brand-new state, the surface of the fixing roller including a parting layer, as a surface layer, formed of a fluorine-containing resin material or the like is in a state close to a mirror surface, and a surface roughness thereof is about 0.02 μm to about 0.05 μm in terms of a three-dimensional arithmetic average roughness Sa defined by ISO 25178. In contrast thereto, in a region (sheet-passing portion), of the fixing roller surface, through which recording paper passes, the fixing roller surface is gradually roughened by damage sustained by fibers of the paper, a filler of the paper, an internal additive for the toner, and the like, so that Sa gradually increases up to about 0.1 μm.

On the other hand, in a region (non-sheet-passing portion), of the fixing roller surface, through which the recording paper does not pass Sa slowly increases up to about 0.1 μm compared with the sheet-passing portion while the surface layer of the fixing roller contacts the pressing roller for forming the nip in combination with the fixing roller. In contrast thereto, a portion on the fixing roller surface through which paper edges of the recording paper at end portions sustains larger damage than other portions by sharp paper edges, so that the damage gradually increases up to about 0.2-0.5 μm in terms of Sa.

As a result, the surface roughness of the fixing roller after continuous printing has the relationship of: (Paper-edge-passing portion)>(Sheet-passing portion)>(Non-sheet-passing portion), so that stripe-shaped damage is formed with respect to a rotational direction of the fixing roller at the paper-edge passing portion on the fixing roller surface.

Japanese Laid-Open Patent Application (JP-A) 2012-173383 discloses a method in which damage is made less conspicuous by rubbing the fixing roller surface with respect to a rotational direction by using a rotatable abrasive member to uniformize a surface roughness. JP-A 2009-151231 discloses a technique for suppressing a lowering in image quality by rubbing the fixing roller with a rubbing (sliding) member in a direction crossing the rotational direction of the fixing roller to extend a parting layer thereby to cover deep damage.

### SUMMARY OF THE INVENTION

According to an aspect of the present invention, there is provided an image heating apparatus comprising: a rotatable member configured to heat a toner image on a recording material, wherein the rotatable member includes a parting layer at a surface thereof; a heating portion configured to heat the rotatable member; a slidable member slidable on the parting layer, wherein the slidable member includes a surface layer having a surface roughness larger than a surface roughness of the parting layer; and a moving mechanism configured to move the slidable member relative to the rotatable member, which is in a rotating state, in a direction crossing with a rotational direction of the rotatable member so that a part of exfoliated matter of the parting layer and/or the surface layer is welded on the parting layer.

These and other objects, features and advantages of the present invention will become more apparent upon a consideration of the following description of the preferred embodiments of the present invention taken in conjunction with the accompanying drawings.

### BRIEF DESCRIPTION OF THE DRAWINGS

FIG. 1 is a sectional view of an image forming apparatus in Embodiment 1.

FIG. 2 is a sectional view of a fixing device during an operation in a fixing operation mode in Embodiment 1.

FIG. 3 is a control block diagram of the fixing device.

FIG. 4 is a sectional view of the fixing device during an operation in a repairing mode.

FIG. 5 is a sectional view of a heater holder and a ceramic heater of a sliding device (rubbing device).

FIG. 6 is a sectional view of a sliding sheet of the sliding device.

FIG. 7 is a schematic view for illustrating a sliding mechanism for subjecting the sliding device to reciprocating motion.

FIG. 8 is a schematic view showing a rotating state of a cam of the sliding mechanism.

FIG. 9 is a schematic view for illustrating a force received by a fixing roller surface in the sliding portion.

In FIG. 10, (a) to (c) are schematic views for illustrating a damage repairing image for a fixing roller in a sliding portion (rubbing portion).

In FIG. 11, (a) to (c) are observation views of a parting layer surface of the fixing roller when a temperature of the sliding portion is changed.

FIG. 12 is a graph showing a relationship between a change, with time, of a surface roughness of paper edge portion of the fixing roller and a surface roughness of a sliding sheet.

FIG. 13 is a control blocked diagram of a fixing device in Embodiment 2.

FIG. 14 is a sectional view showing a relation between a fixing roller and a sliding device in an operation in a repairing mode for the fixing device.

FIG. 15 is a front view of the fixing roller and the sliding device in the operation in the repairing mode for the fixing device as seen from a feeding direction side.

FIG. 16 is a sectional view showing a state in which a surface roughness of a sliding roller of the sliding device is recovered (refreshed).

FIG. 17 is a front view showing the state in which the surface roughness of the sliding roller of the sliding device is recovered as seen from the feeding direction side.

FIG. 18 is a block diagram for illustrating a hardware structure used for refreshing (recovering) the surface roughness of the sliding roller.

FIG. 19 is a flowchart for illustrating an operation for refreshing the surface roughness of the sliding roller.

### DESCRIPTION OF THE EMBODIMENTS

Embodiments of the present invention will be described specifically with reference to the drawings. Although the following embodiments are examples of preferred embodiments of the present invention, the present invention is not limited thereto, but constitutions thereof can also be replaced with other constitutions within the scope of the concept of the present invention.

### Embodiment 1

### (1) Image Forming Apparatus 100

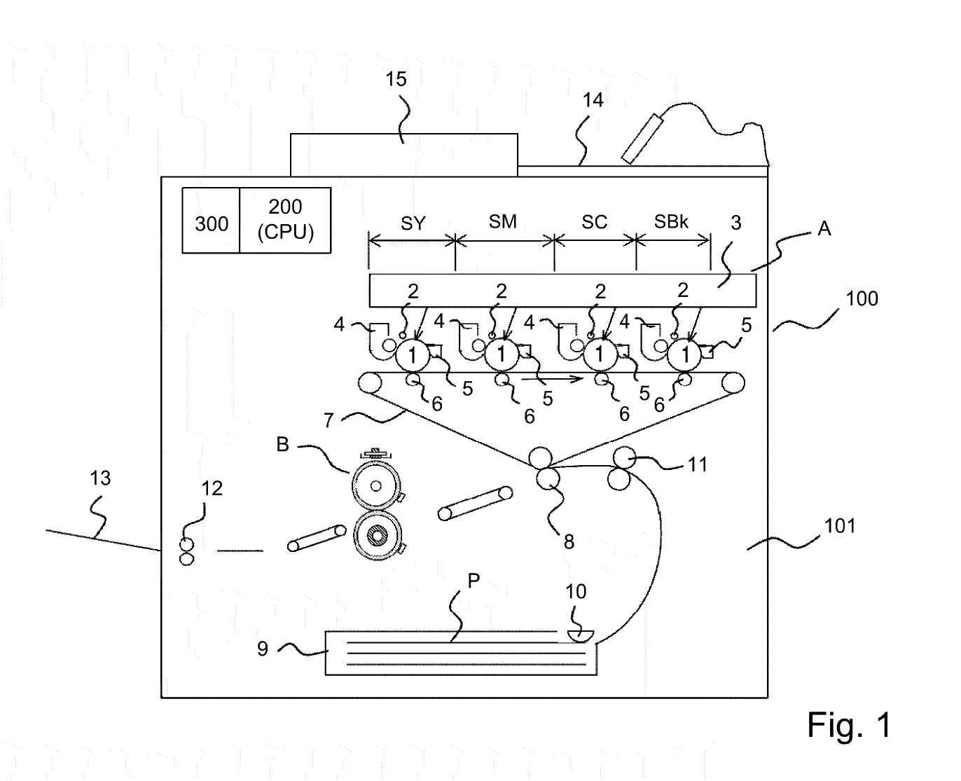

With reference to FIG. 1, an image forming apparatus 100 in which an image heating apparatus according to the present invention is mounted as a fixing device will be described. FIG. 1 is a schematic sectional view of an example of the image forming apparatus 100 (full-color printer in this embodiment) using electrophotographic recording technology.

In the image forming apparatus 100, an image forming portion A for forming a toner image on a recording material P includes image forming stations SY, SM, SC and SBk for yellow, magenta, cyan and black, respectively. Each of the image forming stations includes a photosensitive drum 1 as an image bearing member, a charging member 2, a laser scanner 3, a developing device 4, and a cleaner 6 for cleaning the photosensitive drum 1.

Further, each image forming station includes a transfer member 6, a belt 7 for feeding a toner image transferred from the photosensitive drum 1 by the transfer member 6 while carrying the toner image, and a secondary transfer member 8 for transferring the toner image from the belt to the recording material P. An operation of the image forming portion A is well known and will be omitted from description.

The recording material P accommodated in a cassette 9 in a main assembly of the image forming apparatus 100 is fed one by one by rotation of a roller 10. The recording material P is fed by rotation of a roller 11 to a secondary transfer nip formed between the belt 7 and a secondary transfer member 8. The recording material P on which the toner image at the secondary transfer nip is sent to a fixing device (fixing portion) B, and then the toner image is heat-fixed on the recording material P by the fixing device B. The recording material P coming out of the fixing device B is discharged on a tray by rotation of a roller 12. The image forming apparatus 100 further includes an operating portion 14, an original reader (image scanner) 15, a controller (CPU) 200 and a printer controller 300.

### (2) Fixing Device B

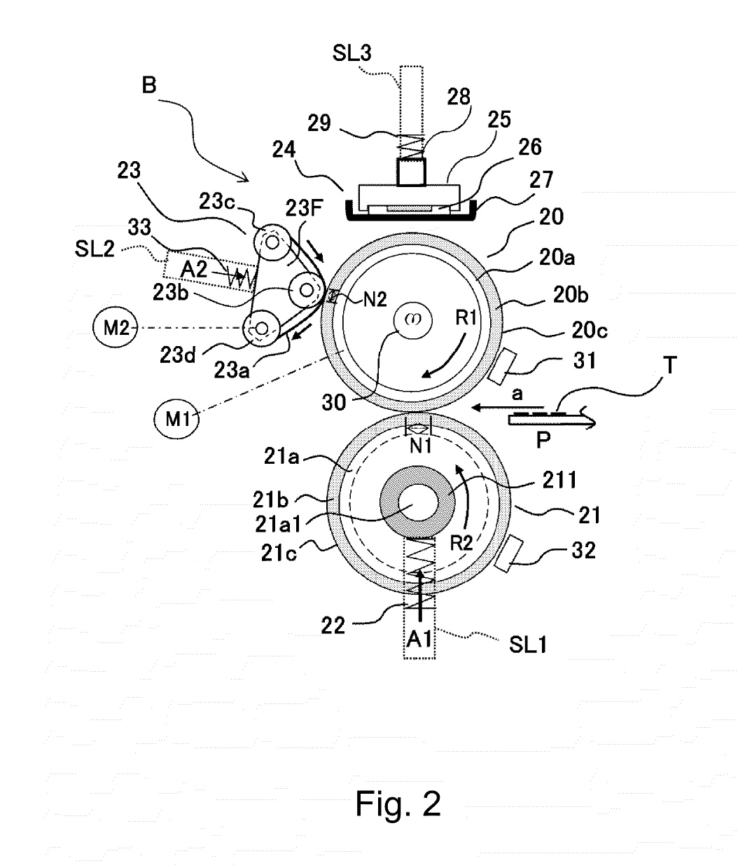

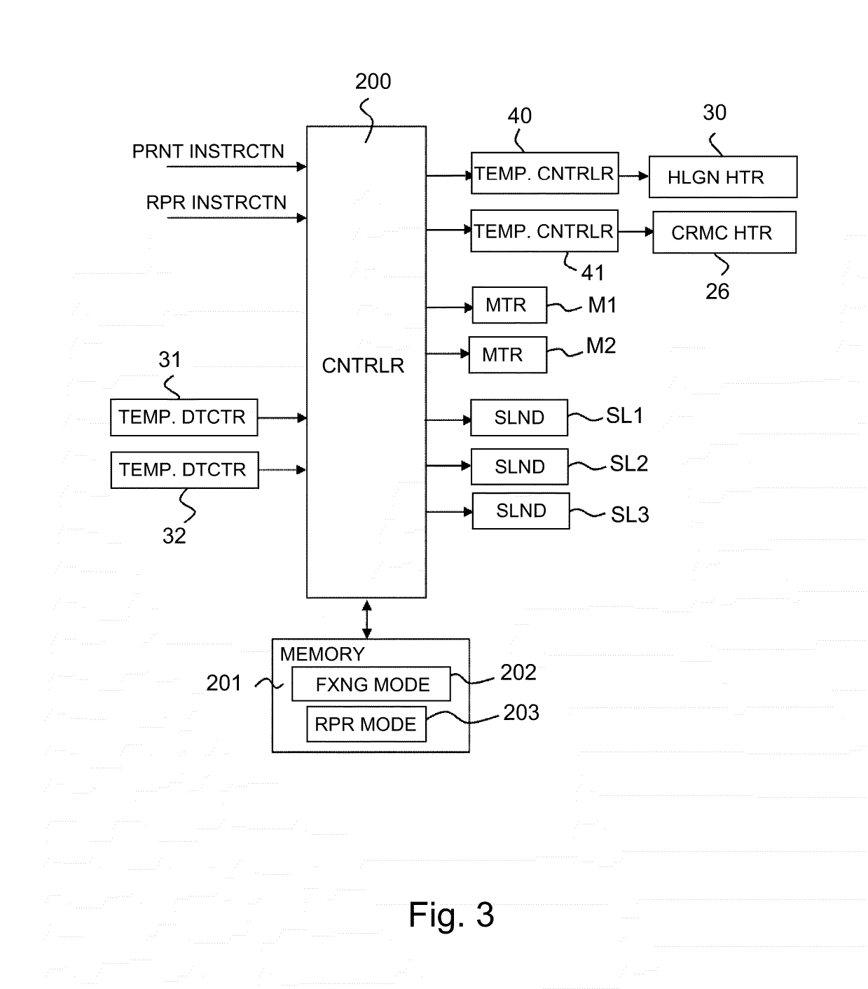

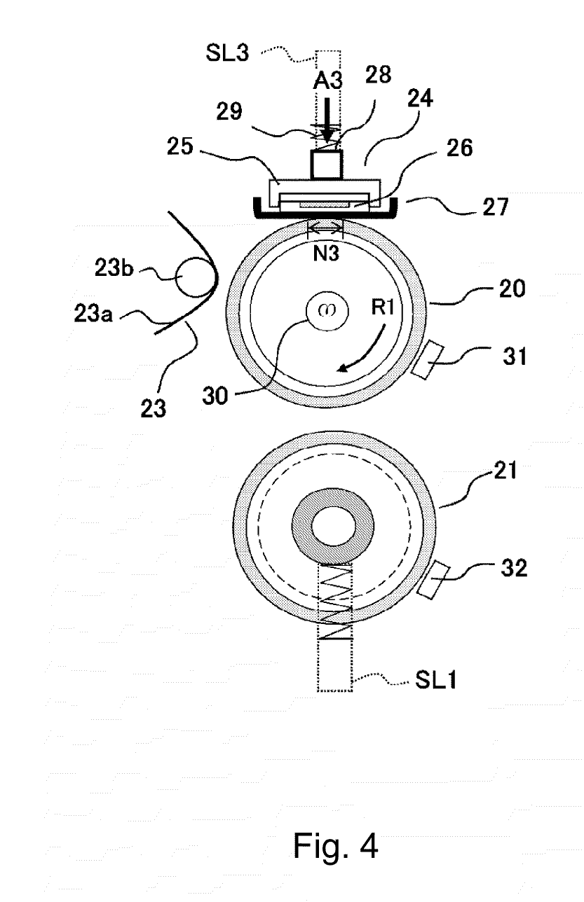

FIG. 2 is a schematic sectional view of the fixing device B in this embodiment during an operation in a fixing mode. FIG. 3 is a control block diagram of the fixing device B. FIG. 4 is a schematic sectional view of the fixing device B during an operation in a repairing mode. The fixing device B in this embodiment is a device of an oil-less fixing type in which no oil is applied onto an outer peripheral surface of a fixing roller 20.

The fixing device B includes the fixing roller 20 and a pressing roller (back-up member) 21 which are rotatable members for forming a nip N. The fixing device B further includes a cleaning device 23, a sliding device 24, a halogen heater (heating portion) 30, a temperature detecting element 31 for detecting a temperature of the surface of the fixing roller 20, and a temperature detecting element 32 for detecting a temperature of the surface of the pressing roller 21.

Further, the fixing device B is capable of performing an operation in a repairing mode in addition to an operation in a fixing operation mode. In a memory 201 such as RAM or ROM, a fixing operation mode 202 and a repairing mode 203 are stored. The controller 200 consisting of CPU executes the operation in the fixing mode 202 when a print instruction (command) is inputted, and executes the operation in the repairing mode 203 when a repairing instruction (command) is inputted.

In the operation in the fixing operation mode 202, a heat-fixing operation for fixing the (unfixed) toner image T, carried on the recording material P, on the recording material P is performed. In the operation in the repairing mode 203, a repairing for repairing damage (surface layer damage) generated on the surface of the fixing roller 20 is performed.

The fixing roller 20 includes an aluminum hollow core metal 20a of about 76 mm in outer diameter and an elastic layer 20b formed of a silicone rubber on the core metal 20a. On the elastic layer 20b, as a toner parting layer, a 30 μm-thick parting layer 20c is formed of tetrafluoroethylene-perfluoroalkylvinyl ether copolymer (PFA). An outer diameter of the fixing roller 20 is 80 mm.

The parting layer 20c may preferably be formed of a material having a heat-resistant property and a parting property. As the material for the parting layer 20c, it is possible to use a fluorine-containing resin material such as PFA, polytetrafluoroethylene (PTFE) or tetrafluoroethylene-hexafluoropropylene copolymer (FEP).

A thickness of the parting layer 20c may preferably be about 5-500 μm in view of durability or the like. When a heat resistance of the parting layer 20c is also taken into consideration, the thickness may further preferably be about 50-100 μm. Further, in order to enhance are efficiency of heat conduction to the toner, thermal conductivity may also be increased by adding an electroconductive agent such as carbon black.

The fixing roller 20 is rotatably held by a frame (not shown) of the fixing device B via bearings at end portions (not shown) of the core metal 20a.

The halogen heater 30 disposed inside the core metal 20a of the fixing roller 20 is held at end portions thereof by the frame described above.

The pressing roller 21 has the same constitution as that of the fixing roller 20, and includes a hollow core metal 21a, an elastic layer 21b, and a parting layer 21c.

The pressing roller 21 is held movably in a radial direction of the fixing roller 20 in a state in which end portions 20a1 of the core metal 21a are supported by the above-described frame via bearings 211. Each bearing 211 is pressed by a pressing spring 22 in a direction (arrow A1 direction in FIG. 2) in which the bearing 211 approaches the fixing roller 20, so that the surface of the pressing roller 21 is contacted to the surface of the fixing roller 20 and thus a nip N1 (FIG. 2) having a predetermined width is formed by the pressing roller surface and the fixing roller surface.

In this embodiment, the nip N1 is formed by the pressing roller surface and the fixing roller surface by pressing the pressing roller 21 against the fixing roller 20 with a pressure of 1000 N.

In the fixing device B in this embodiment, as the pressing roller 21, the pressing roller having the same constitution as that of the fixing roller 20 was used, but the pressing roller 21 is not limited thereto. An outer diameter and a rubber hardness of the pressing roller may appropriately be changed so as to optimize a shape of the nip N1.

In the fixing device B in this embodiment, the pressing roller 21 is used as a rotatable member, but a belt-shaped member is used as the rotatable member and may also be pressed against the fixing roller 20 by using a pressing pad (backup member) or the like.

In the fixing device B in this embodiment, the fixing roller 20 is used as a rotatable member, but it is also possible to use a belt-shaped member as the rotatable member. Further, a combination of a plurality of fixing devices B may also be used as the fixing portion.

The cleaning device 23 includes a fibrous cleaning web 23a, an elastic roller 23b, a supplying roller 23c, a winding-up roller 23d and a frame 23F for rotatably holding these rollers. The cleaning web 23a is wound around the supplying roller 23c, and is wound up by the winding-up roller 23d via the elastic roller 23b.

The frame 23F is held movably in the radial direction of the fixing roller 20 by the above-described frame, and is pressed by a pressing spring 33 in a direction (arrow A2 direction in FIG. 2) in which the frame 23F approaches the fixing roller 20. By this pressure (urging force) of the pressing spring 33, the surface of the cleaning web 23a is contacted to the surface of the fixing roller 20 by the elastic roller 23b, so that a cleaning portion N2 (FIG. 2) having a predetermined width is formed by the cleaning web surface and the fixing roller surface.

### (3) Fixing Operation Mode 202

With reference to FIGS. 2 and 3, the operation in the fixing operation mode 202 will be described. The controller 200 drives a motor M1, so that the fixing roller 20 is rotated in an arrow R1 direction. A rotational speed of the fixing roller 20 is set so that a surface moving speed of the fixing roller 20 is 320 mm/sec. By rotation of the fixing roller 20, the pressing roller 21 is rotated in an arrow R2 direction while following the rotation of the roller 20.

Then, a detection temperature of the fixing roller surface monitored by the temperature detecting element 31 and a detection temperature of the pressing roller surface monitored by the temperature detecting element 32 are obtained. Then, on the basis of these detection temperatures, a first temperature control circuit 40 is driven, so that electric power supplied from a power source (not shown) to the halogen heater 30 is controlled. As a result, a state temperature of the fixing roller 20 is maintained at a predetermined fixing temperature (target temperature). In this embodiment, setting is made so that the fixing temperature is 180° C.

Next, a motor M2 is driven, so that the winding-up roller 23d is rotated. By rotation of the winding-up roller 23d, the cleaning web 23a is pulled out from the supplying roller 23c in a direction opposite to the rotational direction of the fixing roller 20, and then is wound up by the winding-up roller 23d while being pressed against the fixing roller surface by the elastic roller 23b.

The recording material P carrying thereon the (unfixed) toner image T is heated by the surface of the fixing roller 20 and the surface of the pressing roller 21 while being nipped and fed through the nip N1, so that the toner image T is heat-fixed on the recording material P. In the nip N1, a foreign matter, such as paper powder of the recording material P or an offset toner, deposited on the surface of the fixing roller 20 is removed by the cleaning web 23a at the cleaning portion N2.

In the fixing device B in this embodiment, in order to prevent a foreign matter deposited on the surface of the fixing roller 20 from being included in a sliding portion N3 described later, with respect to a rotational direction of the fixing roller 20, the cleaning device 23 was disposed between the nip N1 and the sliding portion N3. However, in the case of a fixing device which is mounted in a relatively low-speed image forming apparatus and of which a long durability lifetime is not so required, the cleaning device 23 may be omitted.

Further, even when the fixing device requires the durability lifetime, a constitution in which a brush or the like is used, in place of the cleaning web 23a, for scraping off the foreign matter deposited on the surface of the fixing roller 20 may also be employed.

### (4) Sliding Device 24

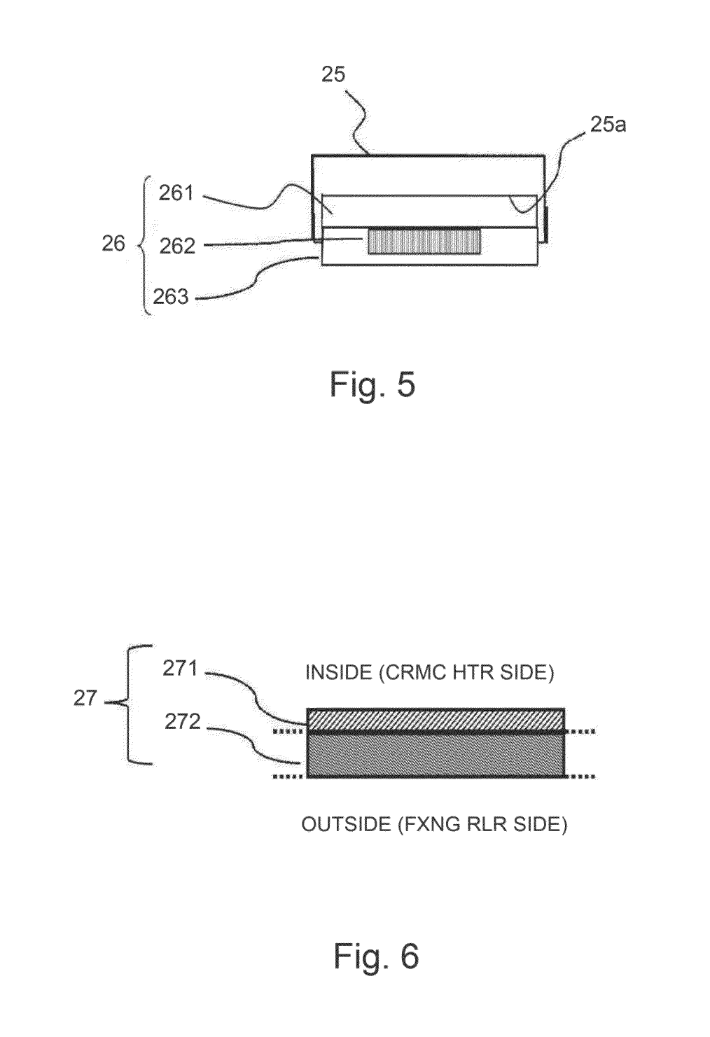

The sliding device 24, for forming a sliding position N3 with the fixing roller 20 will be described. FIG. 5 is a sectional view of a heater holder 25 and a ceramic heater 26 for the sliding device 24. FIG. 6 is a sectional view of a sliding sheet 27 of the fixing device 24.

As shown in FIG. 4, the sliding device 24 includes the heater holder 25, the ceramic heater (heating portion) 26, and the sliding sheet (slidable member) 27. The ceramic heater 26 is held on the surface of the heater holder 25 in the fixing roller 20 side.

The sliding device 24 is held by the above-described frame, movably in the radial direction of the fixing roller 20 at end portions of the holder 25, so that the holder 25 is pressed by a pressing spring 29 in a direction (arrow A3 direction in FIG. 4) in which the holder 25 approaches the fixing roller 20 during the operation in the repairing mode. As a result, the surface of the sliding sheet 27 is contacted to the surface of the fixing roller 20, so that the sliding portion N3 (FIG. 4) having a predetermined width is formed between the film surface and the fixing roller surface.

Further, the sliding device 24 is moved in a direction (opposite to the arrow A3 direction) in which the holder 25 is spaced from the surface of the fixing roller 20 against pressure of the pressing spring 29 by a plunger (not shown) of a solenoid SL3 driven by the controller 200 during the operation in the fixing operation mode. As a result, the sliding sheet 27 is spaced from the fixing roller 20 (FIG. 2).

The ceramic heater 26 is held by a recessed portion 25a (FIG. 5) formed on the surface of the holder 25 in the fixing roller 20 side with respect to a direction perpendicular to the feeding direction a. The ceramic heater 26 includes an elongated substrate 261 (FIG. 5). On the surface of the substrate 261 in the fixing roller 20 side, a heat generating resistor 262 is formed along the direction perpendicular to the feeding direction a in the fixing roller 20 side, and a protective layer 263 is formed so as to cover the heat generating resistor 262.

The substrate 261 is an insulative ceramics substrate of alumina, aluminum nitride or the like or a heat-resistant resin substrate of polyimide, PPS, a liquid polymer or the like. The heat generating resistor 262 is prepared by subjecting a paste of a material, such as Ag/Pd (silver/palladium), RuO₂ or Ta₂N, to screen printing and then by baking the paste. The heat generating resistor 262 has a linear shape of about 10 mm in thickness, about 1-5 mm in width and about 300 mm in length. The protective layer 263 is formed of glass.

The holder 25 is formed of a heat-resistant resin material, such as the liquid crystal polymer, phenolic resin, PPS or PEEK. With a lower thermal conductivity of the holder 25, a heat efficiency with respect to heating of the surface of the fixing roller 20 becomes higher, and therefore it is desirable that a material having a low thermal conductivity is used as material for the holder 25.

On a back surface, of the ceramic heater 26, opposite from the fixing roller 20, a temperature detecting element (not shown) such as a thermistor is provided for the purpose of temperature-controlling the ceramic heater 26 or for the purpose of monitoring abnormal temperature rise of the ceramic heater 26.

The sliding sheet 27 will be described. In this embodiment, on the surface of the ceramic heater 26 in the fixing roller 20 side, the sliding sheet 27 excellent in parting property and sliding property was bonded and disposed.

The sliding sheet 27 is used for not only suppressing deposition of the toner, offset on the surface of the fixing roller 20, on the ceramic heater 26 but also reducing a frictional force due to sliding with the fixing roller 20. For that reason, as shown in FIG. 6, a surface layer 272 of the sliding sheet 27 may preferably be formed of a material having the heat-resistant material and the parting property. For example, other than PFA, it is possible to use the fluorine-containing resin material such as PTFE or FEP.

Further, when the thickness of the surface layer 272 is excessively thin, durability becomes insufficient, and therefore the thickness may preferably about 10-100 μm, and the sliding sheet 27 may preferably include a base layer 271, as a layer under the surface layer 272, formed with a film of polyimide which is a heat-resistant resin material or a nickel film which is a metal film.

In this embodiment, as the sliding sheet 27, a sheet-like member is used, but in order to lower a contact heat resistance with the ceramic heater 26, the fluorine-containing resin material may also be directly coated on the surface of the ceramic heater 26.

Further, although described later, repairing is promoted by welding of an exfoliated matter of the surface layer 272 of the sliding sheet 27 on damage generated on the parting layer 20c of the fixing roller 20, and therefore as the material for the surface layer 272, it is further preferable that a resin material which is the same as a resin material for the parting layer 20c is used. Further, from the view point of welding the exfoliated matter exfoliated from the surface layer 272, rather than the resin material such as PTFE which has a high melt viscosity and which is not readily molded, a recording material such as PFA which has a low melt viscosity and which is readily molded may preferably be used.

Further, a surface roughness of the sliding sheet 27 is larger than a surface roughness of the parting layer 20c of the fixing roller 20. In this embodiment, as the surface roughness, a three-dimensional arithmetic average roughness Sa (measured by “Micromap” manufactured by Ryoka Systems, Inc.) defined by ISO 25178 was used. This is, when Sa of the surface layer 272 is Sa1 and Sa of the parting layer 20c is Sa2, the following formula (1) is satisfied.

Sa1>Sa2 (1)

As the surface roughness, a ten-point average roughness Rz or an arithmetic average roughness Ra which is measured at a plurality of cross sections and which is then obtained as an average of measured values may also be used. When the surface roughness of the surface layer 272 may only be required to be higher than the surface roughness of the parting layer 20c when compared using the same index.

Sa is about 0.5 as a maximum even at a paper edge passing portion where the surface of the fixing roller 20 is most roughened. For this reason, in this embodiment as the material for the surface layer 272 of the sliding sheet 27, PFA having Sa of 1.0 was used. The roughened surface was formed by being rubbed with a sandpaper, but a roughening method is not limited thereto. For example, the surface may also be roughed by sand blasting.

The reason why the surface roughness of the sliding sheet 27 may preferably be high will be described in (5) below, but when the surface roughness is large, a starting point from which the exfoliated matter is formed is increased. As a result, the exfoliated matter is formed in a large amount from the sliding sheet 27 side, so that a repairing speed of the damage of the surface of the fixing roller 20 is increased.

### (5) Repairing Mode 203

The operation in the repairing mode will be specifically described with reference to FIGS. 2-4. In the operation in the repairing mode, the sliding device is contacted to the fixing roller and therefore in order to lower a driving torque of the fixing roller, the fixing roller and the pressing roller are spaced from each other as shown in FIG. 4. In that state, after the foreign matter deposited on the fixing roller surface is removed by the cleaning web 23a of the cleaning device 23 by rotating the fixing roller 20, the cleaning device 23 is spaced from the fixing roller 20.

Thereafter, the sliding sheet 27 of the sliding device 24 is contacted to the fixing roller 20 to form the sliding portion N3, and in a state in which the fixing roller is rotated, the sliding device 24 is reciprocated in the axial direction of the fixing roller 20. As a result, in the sliding portion N3, a part of abrasion powder (exfoliated matter), of the surface layer 272 of the sliding sheet 27 and/or the parting layer 20c of the fixing roller 20, generated by the reciprocating motion of the sliding device 24 is welded on the parting layer 20c to repair the damage of the fixing roller surface.

Also in the operation in the repairing mode, setting is made so that the surface moving speed of the fixing roller 20 is 320 mm/sec and the surface temperature of the fixing roller 20 is 180° C.

When a solenoid SL1 is driven (turned on) by the controller 200, the solenoid SL1 moves the bearing 211 of the pressing roller 21 by a plunger (not shown) in a direction opposite to an arrow A2 direction in FIG. 2 against pressure of the pressing spring 22. As a result, the pressing roller 21 is spaced from the fixing roller 20 (FIG. 4).

Further, when the motor M1 is driven, the fixing roller 20 is rotated in the arrow R1 direction at the surface moving speed of 320 mm/sec by the drive of the motor M1. Then, when the motor M2 is driven, the winding-up roller 23d is rotated by the drive of the motor M2. As a result, the cleaning web 23a is pulled out from the supplying roller 23c, so that the foreign matter, such as the paper powder or the offset toner, deposited on the surface of the fixing roller 20 at the cleaning portion N2.

Further, when the solenoid SL2 is driven (turned on), the solenoid SL2 moves the frame 23F of the cleaning device 23 by a plunger (not shown) in a direction opposite to the arrow A2 direction in FIG. 2 against pressure of the pressing spring 33. As a result, the cleaning web 23a is spaced from the fixing roller 20 (FIG. 4).

Further, when the solenoid SL3 is driven (turned off), the holder 25 of the sliding device 24 is pressed by the pressing spring 29 in the direction (arrow A3 direction in FIG. 4) in which the holder 25 approaches the fixing roller 20, so that the surface of the sliding sheet 27 contacts the surface of the fixing roller 20. As a result, the sliding portion N3 having the predetermined width is formed by the surface of the sliding sheet 27 and the surface of the fixing roller 20.

In FIG. 4, a roller 28 rolls on the holder 25 with movement of the holder 25 of the sliding device 24, the pressing spring 79 presses the holder 25 in the arrow A3 direction via the roller 28a.

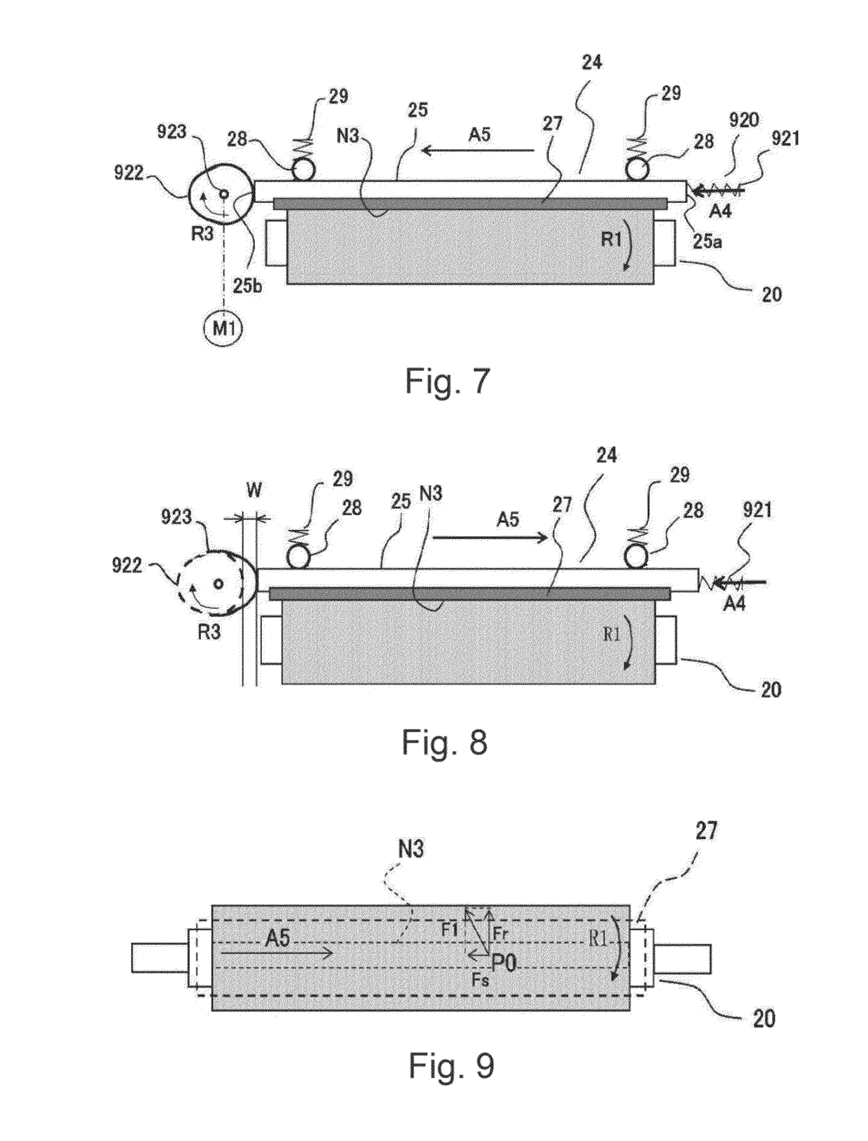

Further, a cam 922 (FIG. 7) of a sliding mechanism 920 described later is rotated by drive of the motor M1. By the rotation of the cam 922, the sliding device 24 is reciprocated in the axial direction of the fixing roller 20.

By the reciprocating motion of the sliding device 24, in the sliding portion N3, the abrasion powder (exfoliated matter) of the surface layer 272 and/or the parting layer 20c is generated. This abrasion powder is caught by the surface layer 272 of the sliding sheet 27 and remains in the sliding portion N3.

Next, the controller 200 obtains the temperature detected by the temperature detecting element 31, and controls electric power supplied from a power source (not shown) to the halogen heater 30 and the ceramic heater 26 by driving temperature control circuits 40 and 41 on the basis of the detection temperature.

In this embodiment, the electric power supplied to the halogen heater 30 and the ceramic heater 26 so that the surface temperature of the fixing roller 20 is 180° C.

The abrasion powder caught by the surface layer 272 of the sliding sheet 27 is melted by being subjected to heat of the fixing roller 71 heated by the halogen heater 30 and heat of the sliding sheet 27 heated by the ceramic heater 26 and further by being subjected to pressure in the sliding portion N3, so that the abrasion powder is melted on the surface of the fixing roller 20. As a result, the damage on the surface of the fixing roller 20 is repaired.

In the fixing device B in this embodiment, in order to enable the reciprocating motion of the sliding device in the axial direction of the fixing roller, the holder 25 is provided with a guiding groove (not shown) parallel to the axial direction, and the plunger of the solenoid SL3 is held slidably by the guiding groove. A length of the guiding groove is longer than a sliding amount W (FIG. 8) described later. That is, the sliding device 24 can move in the axial direction of the fixing roller 20 by a distance equal to the sliding amount W. The axial direction of the fixing roller 20 is a direction crossing with the rotational direction of the fixing roller 20.

FIG. 7 is a schematic view for illustrating the sliding mechanism 920 for reciprocating the sliding device 24 in the axial direction of the fixing roller 20. The sliding mechanism 920 includes the pressing spring 912 and the cam 922, and the cam 922 is rotated by the motor M1 for the fixing roller 20.

The pressing spring 921 presses one end portion 25a of the holder 25 in the arrow A4 direction, i.e., toward the other (opposite) end portion 25b with respect to the direction perpendicular to the feeding direction a at a pressure of 49N. On the other hand, a cam surface of the cam 922 contacts the opposite end portion 25b of the holder 25. A cam shaft 923 of the cam 922 is rotated by drive of the motor M1, so that the cam 922 is rotated in the arrow R3 direction.

A state in which the cam 922 is rotated 180 degrees is shown in FIG. 8. When the cam 922 is rotated 180 degrees, the sliding device 24 is pushed by the cam 922 and is slid in the arrow A5 direction by the sliding amount W. Then, when the cam 922 is further rotated in the arrow R3 direction by 180 degrees, the sliding device 24 is pressed by the pressing spring 920 in the arrow A5 direction in FIG. 7, and thus is returned to the position in FIG. 7.

That is, during rotation of the cam 922 in the arrow R3 direction, the sliding device 24 is reciprocated in the axial direction relative to the rotational direction R1 of the fixing roller 20. At that time, the pressing spring 29 presses the sliding device 24 in the arrow A3 direction in the figure via the roller 28 provided at an end of the pressing spring 29, and therefore the pressing spring is capable of continuously applying the pressure also during sliding movement without being twisted. The cam 922 rotates in the arrow R3 direction during the rotation of the fixing roller 20 and reciprocates the sliding device 24.

As in this embodiment, the cam 922 and the fixing roller 20 may also be rotated by the common motor M1, but the cam 922 and the fixing roller 20 may preferably be rotated by separate motors from the following viewpoint. This is because by rotating the cam 922 and the fixing roller 20 by the separate motors, a rotation period of the fixing roller 20 and a reciprocation period of the sliding device 24 by the rotation of the cam 922 can be made different from each other, and thus a periodical sliding trace by the foreign matter or the like is not readily generated on the fixing roller surface.

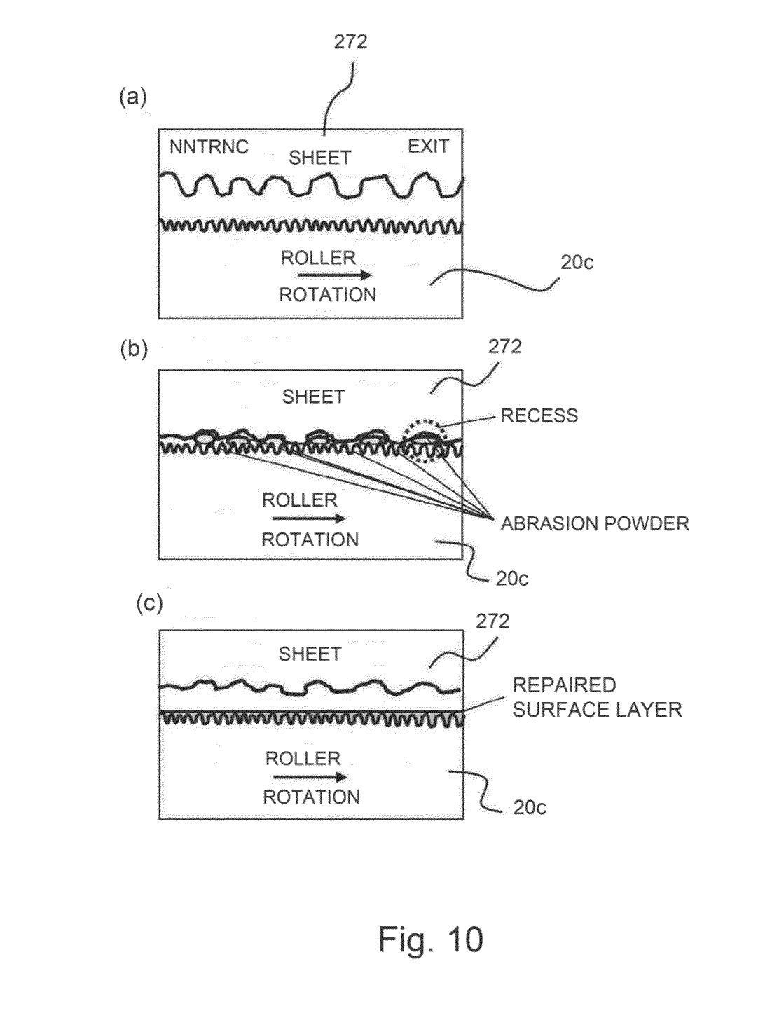

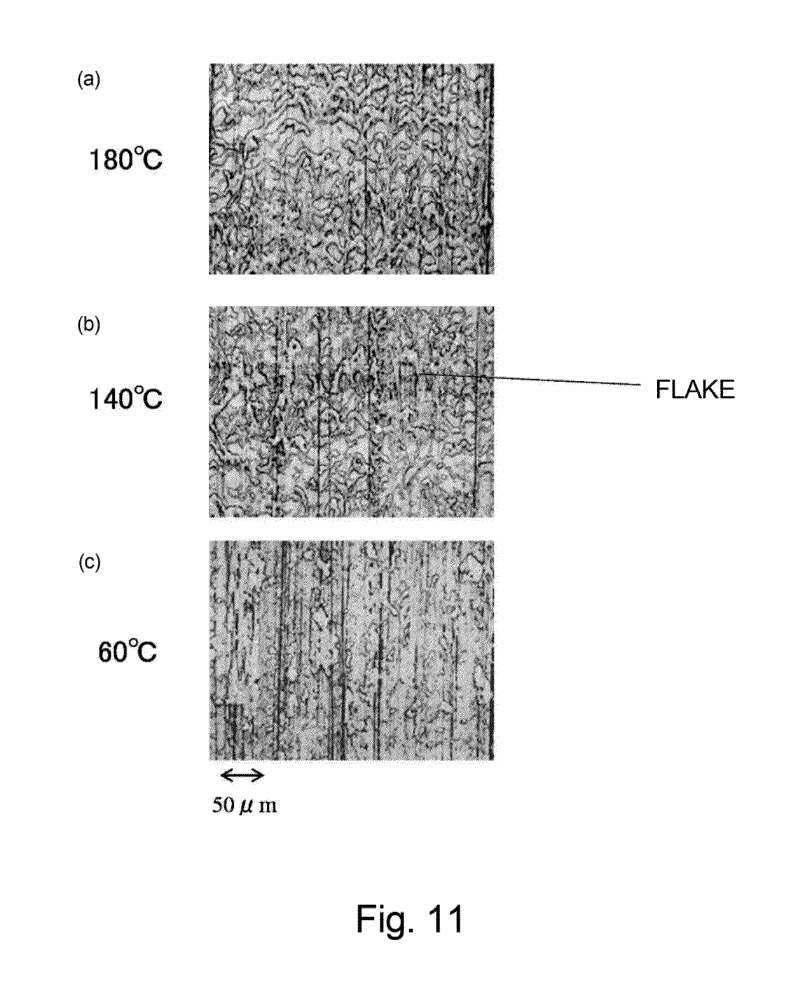

FIG. 9 is a schematic view for illustrating a force received by the surface of the fixing roller 20 in the sliding portion N3. In FIG. 9, in order to clearly indicate the position of the sliding portion N3, the sliding sheet 27 is indicated by a broken line. Referring to FIG. 9, a frictional force exerted on the fixing roller 20 by friction with the sliding sheet 27 during the reciprocating motion of the sliding device 24 will be described.

The fixing roller 20 is rotated in the arrow R1 direction, and at a contact point P0 with the sliding sheet 27, a frictional force Fr directed oppositely to the rotational direction R1 of the fixing roller 20 is exerted on the fixing roller surface. Further, the sliding sheet 27 is reciprocated in the axial direction of the fixing roller 20, and therefore a frictional force Fs directed oppositely to the direction of the reciprocating motion is exerted on the fixing roller surface. In FIG. 9, the frictional force Fs during the reciprocating motion of the sliding sheet 27 in the arrow A5 direction in the figure was shown.

As the resultant of the above-described two frictional forces Fr and Fs, the surface of the fixing roller 20 receives a frictional force F1. In this way, the sliding sheet 27 is reciprocated, and therefore the frictional force F1 includes a component other than the component of the rotational direction R1 of the fixing roller 20, and also a magnitude of the force periodically varies with time.

In this way, by reciprocating the sliding sheet 27 in the axial direction relative to the fixing roller 20 in the rotating state, when the foreign matter such as the paper powder is sandwiched in the sliding portion N3, the foreign matter can pass through the sliding portion N3. The frictional force exerted on the foreign matter is generated also in a direction other than the rotational direction as described above, and therefore the foreign matter is rotated by the force and thus easily slips through the sliding portion N3. From the above, the foreign matter does not damage the same place on the surface of the fixing roller 20, so that it is possible to suppress generation of deep damage on the fixing roller surface.

Next, a damage repairing mechanism of the surface of the fixing roller 20 in the case where the frictional force F1 generates in the sliding portion N3 will be described. In FIG. 10, (a) to (c) show a damage repairing image of the fixing roller 20 in the sliding portion N3. In FIG. 10, (a) is a schematic sectional view showing a state immediately before sliding friction between the sliding sheet 27 and the fixing roller 20, (b) is a schematic sectional view showing a state during the sliding between the sliding sheet 27 and the fixing roller 20, and (c) is a schematic sectional view showing a state after the damage of the fixing roller 20 is repaired.

As shown in (a) of FIG. 10, immediately before the sliding sheet 27 and the fixing roller 20 are slid and rubbed with each other, the surface of the surface layer 272 of the sliding sheet 27 is roughened more than the surface of the parting layer 20c of the fixing roller 20, so that on the surface of the surface layer 272, projections higher than projections on the surface of the parting layer 20 are formed.

As shown in (b) of FIG. 10, when the sliding friction of the surface layer 272 of the sliding sheet 27 with the parting layer 20c of the fixing roller 20 is started, stress concentrates at the relatively high projections on the surface of the surface layer 272. For that reason, the frictional force is imparted to the projected portion, so that the projected portion is partly broken and peeled off to generate the abrasion powder (exfoliated matter).

At this time, also in the case where the parting layer 20c of the fixing roller 20 is roughened, the stress concentrates at the projected portion of the surface layer 272 of the sliding sheet 27, and therefore the abrasion powder (exfoliated matter) is readily generated. However, when the parting layer 20c is roughened to the extent that the abrasion powder is generated in a sufficient amount, the abrasion powder is recognized as an image defect. For that reason, it is desirable that the function of increasing the abrasion powder by increasing the surface roughness is performed by the sliding sheet 27.

In order to obtain the frictional force capable of generating the abrasion powder from the surface layer 272 of the sliding sheet 27 and/or the parting layer 20c of the fixing roller 20, a contact pressure peak of the sliding portion N3 was set at 5.0×10⁵ (N/mm²). In order to effectively generate the abrasion powder, the contact pressure peak may preferably be 9.8×10⁴ (N/mm²) or more. Further, in order to effectively generate the abrasion powder, the surface roughness Sa of the surface layer 272 may preferably be 1.0 μm or more. The surface roughness Sa of the surface layer 272 is better with a larger value, but a generation amount of the abrasion powder is localized in the case where the surface roughness Sa is excessively large or in the case where the surface Sa is not uniform, and therefore Sa may preferably be 10 μm or less.

A part of the generated abrasion powder is caught by a portion corresponding to a recessed portion of the surface layer 272 of the sliding sheet 27 as shown in (b) of FIG. 10 and remains in the sliding portion N3 also during the sliding of the sliding sheet 27. The remaining abrasion powder sustains heat of the fixing roller 20 and the sliding sheet 27, pressure by the pressing spring 29, and frictional heat caused by the frictional force F1 generated by friction between the fixing roller and the sliding sheet. As a result, it would be considered that the abrasion powder is melted and deformed while being extended in the direction of the frictional force F1 and thus is welded on the surface of the parting layer 20c of the fixing roller 20.

In order to melt-deform and weld the abrasion powder in actuality, there is a need to increase the temperature up to at least a glass transition temperature of the surface layer 272 of the sliding sheet 27. In this embodiment, PFA is used as the material for the surface layer 272, and the glass transition temperature was 118° C.

Therefore, the sliding sheet 27 is slid with the parting layer 20c of the fixing roller 20 which changing the temperature of the sliding portion N3 under a pressure condition of this embodiment in the neighborhood of the glass transition temperature, and thereafter the surface of the parting layer 20c was observed through a polarizing microscope. A result is shown in FIG. 11. In FIG. 11, as is apparent from a photograph of the surface of the parting layer 20c at 140° C. ((b) of FIG. 11) higher than the glass transition temperature, it turned out in this embodiment that a so-called flake (scale) having such a shape like scales which would be generated by the welding of the abrasion powder on the parting layer 20c.

In this embodiment, the temperature during the sliding of the sliding sheet 27 was 180° C. equal to an image fixing temperature, and therefore it was possible to perform a welding operation for effectively welding the part of the abrasion powder on the damage of the surface of the parting layer 20c of the fixing roller 20. In actuality, when the surface of the parting layer 20c on which the sliding surface layer 27 is slid is observed through the polarizing microscope, as shown in a photograph of the surface of the sliding sheet 27 at 180° C. ((a) of FIG. 11), the part of the abrasion powder is extended and inflamed so as to cover the damage to form the surface where the damage is covered, and thus supports the above-described hypothesis.

In this embodiment, the sliding amount W of the sliding device 24 by the cam 921 was 1 mm, so that it was possible to effectively repair the damage of the surface of the parting layer 20c of the fixing roller 20. However, the sliding amount may preferably be large to the possible extent, and therefore the sliding amount may be changed depending on a product constitution of an actual fixing device.

As described above, a repairing speed of the damage correlates with the surface roughness of the sliding sheet 27. As a comparison example, the above-described study on the sliding was made with the surface roughness Sa, of the surface layer 272 of the sliding sheet 27, being 0.02 μm which is substantially equal to the surface roughness Sa of a smooth surface. In this study on the sliding, a fixing roller which had the surface roughness Sa of 0.5 μm at the paper edge passing portion and which was subjected to a durability test was prepared. A degree of refreshing (recovery) of a surface property of the fixing roller at the paper edge passing portion was compared with that of the sliding sheet 27 having the surface roughness Sa of 1.0 μm in this embodiment.

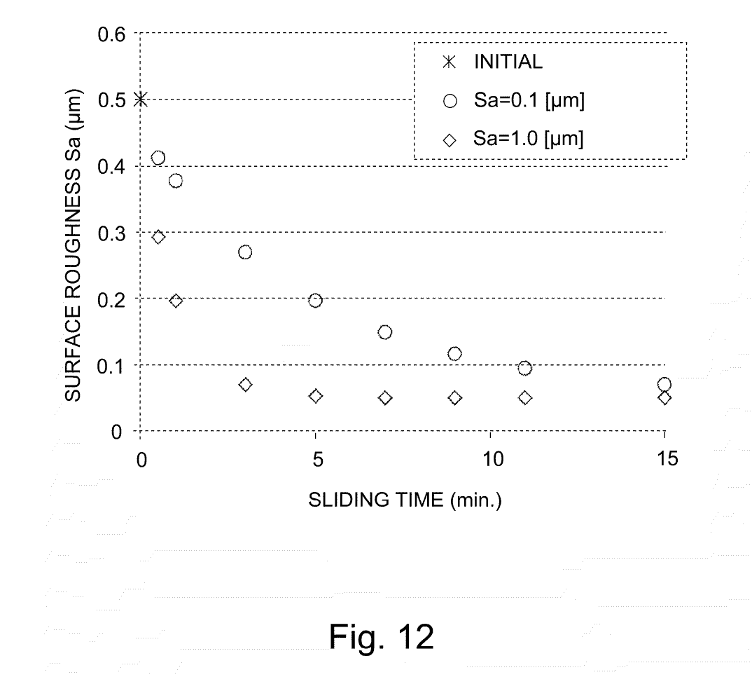

FIG. 12 shows a change in surface roughness Sa with time of the fixing roller at the paper edge passing portion in the case where the surface roughness Sa of the sliding sheet 27 is 1.0 μm and in the case where the surface roughness Sa is 0.1 μm. From FIG. 12, a refreshing speed of the surface property higher with a large surface roughness of the sliding sheet, so that Sa at the paper edge passing portion becomes about 0.05 μm in several minutes. At this time, when the recording material carrying thereon the unfixed toner image was introduced into the nip and an image glossiness of the toner image heat-fixed on the recording material was measured, the glossiness was not different from the glossiness in the case of an unused fixing roller, and there was no stripe-shaped damage.

From the above, in accordance with the above-described assumed mechanism, it turned out that the fixing roller was repaired earlier with a higher surface roughness Sa of the sliding sheet 27.

A printing durability test was conducted using the fixing device B in this embodiment and the fixing device in the comparison example and results were compared. The printing durability test was performed by continuously printing an image of a print ratio of 5%, and the fixing roller damage was checked every 1,000 sheets up to 10,000 sheets and every 10,000 sheets after 10,000 sheets. The fixing roller damage check was made by the presence or absence of the vertical stripe on a solid image formed on each of plain paper and glossy paper.

In the fixing device B in this embodiment, the sliding sheet 27 is reciprocated in a contact rotation state with the fixing roller 20. For this reason, up to 10,000 sheets which is a durable lifetime of the fixing device B in this embodiment, a depth of the surface damage of the parting layer of the fixing roller can be suppressed, and even when the image is formed and fixed on the glossy paper on which the vertical stripe is easily visible, the image defect having a vertical stripe shape was not generated on the solid image until the end of the durable lifetime of the fixing device B.

In the fixing device in the comparison example in which the parting layer surface of the fixing roller is rotation-rubbed with a rubbing member, the surface roughness Sa of the parting layer surface become 0.2 μm or more at the time of printing of 4,000 sheets, so that the vertical stripe generated on the solid image formed on the glossy paper. Further, at the time of printing of 30,000 sheets, the surface roughness Sa of the parting layer surface damage became 0.4 μm or more, so that the vertical stripe generated on the image also in the case where the solid image was formed on the plain paper.

Further, even when an unevenness resulting from the abrasion powder was formed on the surface of the parting layer 20c of the fixing roller 20 by the damage repairing method in this embodiment, such an inconvenience that the glossiness was lowered by the formation of the unevenness was not generated. This is because when the abrasion powder is welded, the abrasion powder is sufficiently extended by the heating and the frictional force and thus such an extremely stepped portion as to lead to a lowering in glossiness is not created on the surface of the parting layer 20c.

In the case where minute damage is generated by such a method that the surface property of the parting layer of the fixing roller is maintained (refreshed) at a constant level, e.g., by using an abrasive member, the parting layer surface has uniformity but is lowered in surface glossiness. On the other hand, the surface of the parting layer 20c of the fixing roller 20 in the fixing device B in this embodiment is high in not only a gloss property but also uniformity of the surface roughness.

In the fixing device B in this embodiment, the fixing roller 20 is fixed and the sliding sheet 27 is reciprocated, so that the fixing roller 20 and the sliding sheet 27 are moved relative to each other, but the sliding sheet 27 is fixed and the fixing roller 20 may also be reciprocated in the axial direction while being rotated. Alternatively, both of the fixing roller 20 and the sliding sheet 27 may also be moved relative to each other in different directions.

The direction in which the fixing roller 20 and the sliding sheet 27 are reciprocated is not limited to the axial direction. For example, the sliding sheet 27 may also be shifted from the rotational axis of the fixing roller 20. As described above, the frictional force Fr generated by the rotation of the fixing roller 20 and the frictional force Fs generated by the reciprocating motion of the sliding sheet 27 are generated. The resultant force F1 of the frictional forces Fr and Fs has the component with respect to the direction other than the rotational direction of the fixing roller 20, and therefore as described above, the generation of the damage is suppressed, and even when the damage is generated, it is possible to cover the damage with the abrasion powder to repair the damage.

As described above, the fixing device B in this embodiment uses the abrasion powder, principally positioned in the sliding sheet 27 side, for repairing the damage of the surface of the parting layer 20c of the fixing roller 20, and therefore it becomes possible to repair the damage at high speed. This effect can be obtained with no problem in a shape other than the roller shape so long as the repairing is made in accordance with the mechanism in this embodiment, and thus a similar effect is achieved also in a fixing device using an endless belt as the rotatable member.

### Embodiment 2

Another embodiment of the fixing device B will be described. The fixing device B in Embodiment 1 enables enhancement in repairing speed by roughening the surface layer 272 of the sliding sheet 27 of the sliding device 24, but the surface layer of the sliding sheet gradually decreases in degree of unevenness with the repairing. For that reason, the repairing speed increasing effect gradually lowers.

In the fixing device B in this embodiment, a sliding device 50 having a constitution different from that of the sliding device 24 in Embodiment 1. The sliding device 50 includes a sliding roller (slidable member) 52 contacting the parting layer 20c of the fixing roller 20, and the surface roughness of the sliding roller 52 is refreshed by a sliding plate (repairing means) 51.

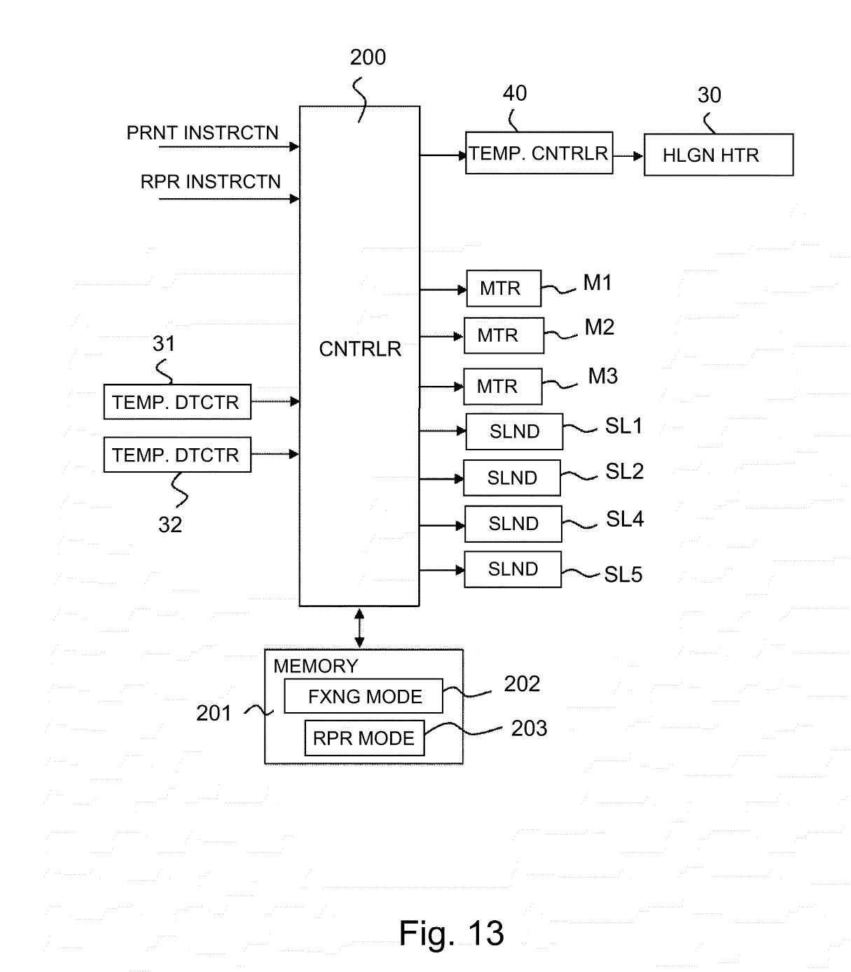

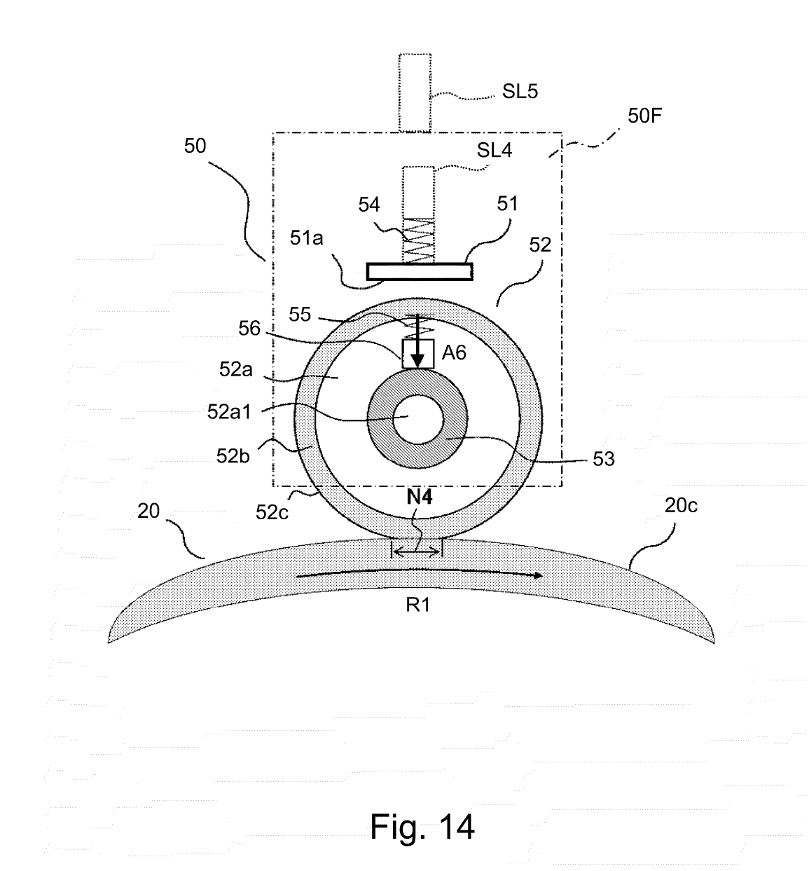

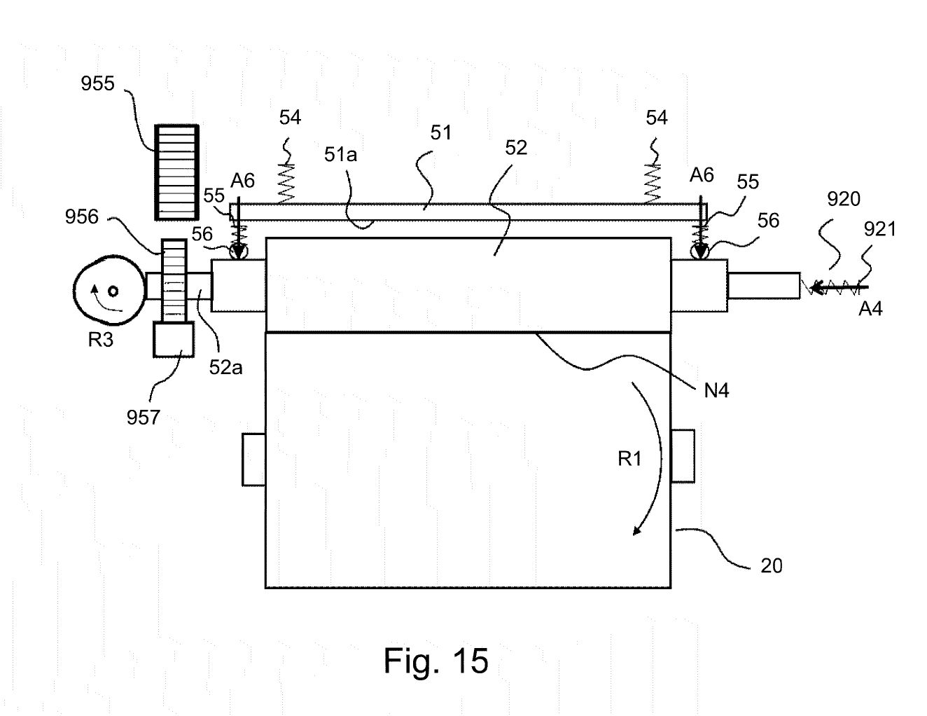

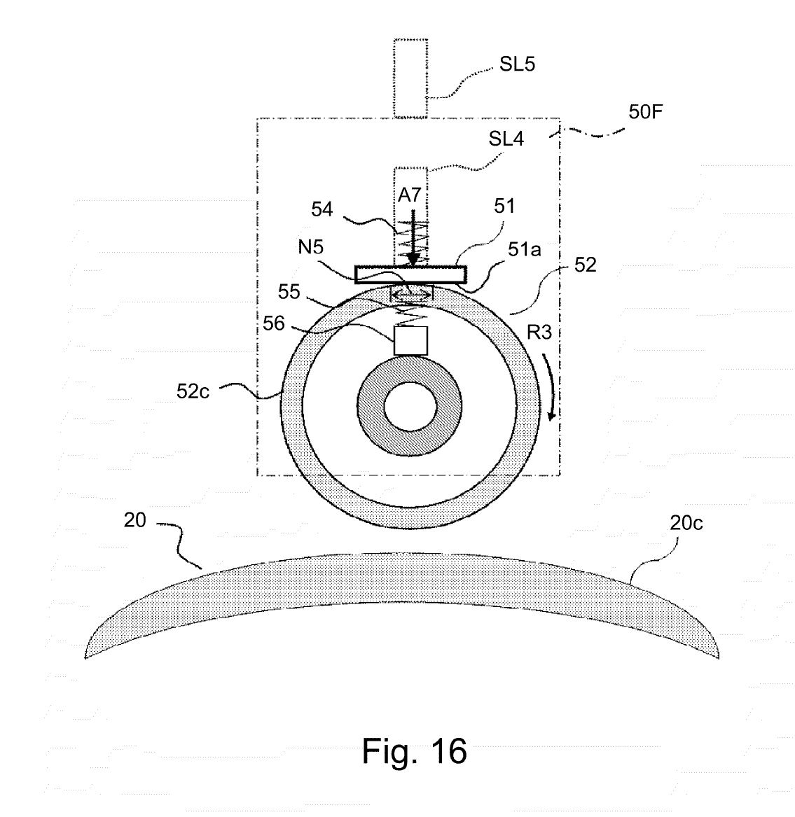

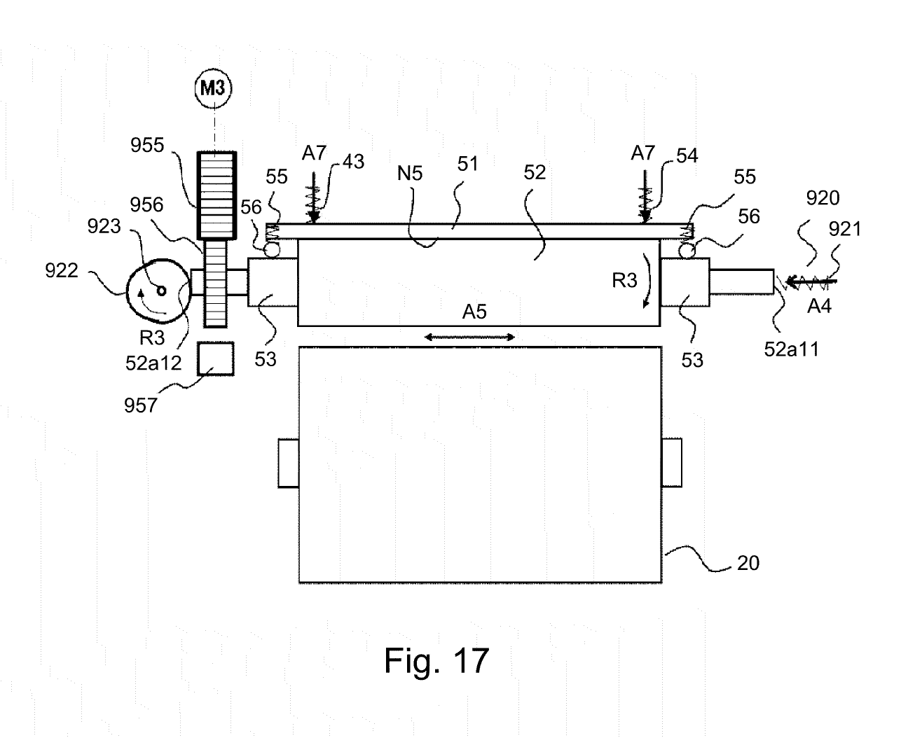

FIG. 13 is a control blocked diagram of the fixing device B in this embodiment. FIG. 14 is a schematic sectional view showing a relation between the fixing roller 20 and the sliding device 50 of the fixing device B during an operation in a repairing mode. FIG. 15 is a front view of the fixing roller 20 and the sliding device 50 of the direction B during the in the repairing mode as seen from the feeding direction a side. FIG. 16 is a schematic sectional view showing a state in which the surface roughness of the sliding roller 51 of the sliding device 50 is refreshed. FIG. 17 is a front view showing a state, as seen from the feeding direction a side, in which the surface roughness of the sliding roller 51 of the sliding device 50 is refreshed.

In the fixing device B in this embodiment, in order to enable the reciprocating motion of the sliding device 50 in the axial direction of the fixing roller 20, a guiding groove (not shown) parallel to the axial direction of the fixing roller 20 is formed on a frame 50F (FIG. 14) of the sliding device 50. Further, a plunger (not shown) of a solenoid SL5 is slidably held in the guiding groove. The length of the guiding groove is longer than a sliding amount of the sliding device 50. That is, the sliding device 50 can be moved in the axial direction of the fixing roller 20 by a distance equal to the sliding amount.

### (1) Sliding Device 50

The sliding device 50 includes the sliding plate 51, the sliding roller 52, a first pressing spring 54 and a second pressing spring 55.

The sliding roller 52 includes a core metal 52a, an elastic layer 52b formed on the core metal 52a, and a parting layer (surface layer) 52c formed on the elastic layer 52b. The sliding roller 52 is rotatably held by the fixing roller 50F via bearing 53 at end portions 52a1 of the core metal 52a.

When the solenoid SL5 is driven (turned off) by the controller 200 during the operation in the repairing mode 203, the bearings 53 at the end portions 52a1 of the core metal 52a of the sliding roller 52 is pressed by the pressing spring 54 in a direction (arrow A6 direction in the figure) in which the bearings 53 approach the fixing roller 20 under a load of 40N. As a result, the surface of the surface layer 52c is contacted to the surface of the parting layer 20c of the fixing roller 20, so that the sliding portion N4 having a width of about 5 mm is formed.

Further, the sliding roller 52 is moved in a direction opposite to the arrow A6 direction in the figure against pressure of the pressing spring 54 by the plunger of a solenoid SL5 when the solenoid SL5 is driven (turned on) by the controller 200 during the operation in the repairing mode 203. As a result, the sliding roller 52 is spaced from the fixing roller 20.

In the sliding roller 52, the core metal 52a is prepared using metal such as Al or iron so as to withstand the above load and to form an objective nip width. The elastic layer 52b is formed using a silicone rubber or a fluorine-containing rubber which has a heat-resistant property. The surface layer 52c is used for suppressing deposition of the toner, offset on the surface of the parting layer 20c of the fixing roller 20, on the sliding roller 52, and is formed of a material having the heat-resistant material and the parting property.

As the material for the surface layer 52c, for example, other than PFA, it is possible to use the fluorine-containing resin material such as PTFE or FEP. Further, when the thickness of the surface layer 52c is excessively thin, durability becomes insufficient, and therefore the thickness may preferably about 10-100 μm.

The sliding roller 52 repairs the damage of the parting layer surface, similarly as in the case of the sliding sheet described above, by welding the abrasion powder of the surface layer 52c thereof on the surface of the parting layer 20c of the fixing roller 20, and therefore as the material for the surface layer 52c, it is preferable that a resin material which is the same as a resin material for the parting layer 20c of the fixing roller 20 is used. Further, from the view point of exfoliation and welding of the abrasion powder, as the material for the surface layer 52c, rather than the resin material such as PTFE which has a high melt viscosity and which is not readily molded, a recording material such as PFA which has a low melt viscosity and which is readily molded may preferably be used.

As shown in FIG. 15, when the sliding roller 52 is pressed by the pressing spring 54 to form the sliding portion N4 with the fixing roller 20, a gear 956 fixed around the core metal 52a of the sliding roller 52 engages with a fixing member 957. This fixing member 957 fixes the sliding roller 52 so as not to rotate when the sliding roller 52 repairs the damage of the surface of the parting layer 20c of the fixing roller 20. The sliding roller 52 is reciprocated in the axis direction of the fixing roller 20 by the sliding mechanism 920 in a state in which the sliding portion N4 is formed between the sliding roller 52 and the fixing roller 20.

As a result, the abrasion powder of the surface layer 52c of the sliding roller 52 and/or the parting layer 20c of the fixing roller 20 is generated in the sliding portion N4, and a part of the abrasion powder is welded on the surface of the parting layer 20c of the fixing roller 20 repairs the damage. In this way, the sliding roller 52 is reciprocated in the axis direction relative to the rotating fixing roller 20, so that even in the case where the foreign matter such as paper powder is sandwiched in the sliding portion N4, the foreign matter rolls and thus easily passes through the sliding portion N4, so that generation of deep damage on the fixing roller surface can be suppressed.

The fixing member 957 is provided with a latitude in width so that the sliding roller 52 does not run off during the reciprocating motion.

In FIG. 15, a roller 56 rotates on the bearing 53 with the movement of the sliding roller 52, and the pressing spring 54 presses the bearing 53 in the arrow A6 direction via the roller 56.

The sliding plate 51 formed in a plate shape is disposed so as to sandwich the sliding roller 52 between itself and the fixing roller 20, and is held at its end portions by the frame 50F so as to be movable in the radial direction of the sliding roller 52. The shape of the sliding plate 51 is not limited to the plate shape. If the sliding plate 51 can roughen the surface of the surface layer 52c of the sliding roller 52, the shape may also be, e.g., a roller shape, a film shape or a brush shape.

The sliding plate 51 may preferably be formed of a material which is sufficiently harder than the surface layer 52c, and is required to be sufficiently roughened as a surface roughness of a sliding surface 51a sliding with the surface of the surface layer 52c of the sliding roller 52. In this embodiment, as the sliding plate 51, a SUS (stainless steel) plate of 10 mm in width and 1 mm in thickness was used, and the sliding surface 51a had the surface roughness Sa of 5.0.

The sliding plate 51 is spaced from the surface layer 52c of the sliding roller 52 when the sliding portion N4 is formed by the sliding roller 52 and the fixing roller 20. That is, during the operation in the repairing mode 203, the solenoid SL4 is driven (turned off), so that the sliding plate 51 is moved by the plunger (not shown) of the solenoid SL4 in a direction (opposite to the arrow A7 direction in FIG. 15) in which the sliding plate 51 is spaced from the sliding roller 52 against pressure of the press spring 53.

Further, the sliding plate 51 is contacted to the surface layer 52c of the sliding roller 52 when the sliding roller 52 is spaced from the fixing roller 20. That is, when the solenoid SL4 is driven (turned on) by the controller 200 during the operation in the repairing mode 203, the sliding plate 51 is pressed by the pressing spring 54 in a direction (arrow 7 direction in FIG. 16) in which the sliding plate 51 approaches the sliding roller 52. As a result, the sliding surface 51a of the sliding plate 51 contacts the surface of the surface layer 52a of the sliding roller 52 to form a sliding portion N5 of about 3 mm in width.

As shown in FIG. 17, when the motor M3 is driven by the controller 200, the sliding roller 52 is rotated in the arrow R3 direction by rotation of the gears 955 and 956. Further, the sliding roller 52 is reciprocated in the axial direction of the fixing roller 20 by the sliding mechanism 920 in a state in which the sliding portion N5 is formed between itself and the fixing roller 20. As a result, the surface of the surface layer 52c of the sliding roller 52 is roughened by being rubbed with the sliding surface 51a of the sliding plate 51, so that the surface roughness of the surface of the surface layer 52c is refreshed.

The sliding plate 51 may also be moved in a widthwise direction of the sliding portion N5. For example, the sliding plate 51 is moved by a distance corresponding to at least a width of the sliding portion N5 by using a rack-and-pinion mechanism and a stepping motor or the like, so that a surface refreshing effect on the surface layer 52c of the sliding roller 52 can be maintained.

In the fixing device B in this embodiment, the sliding plate and the sliding roller are moved relative to each other by fixing the sliding plate 51 and reciprocating the sliding roller 52, but the sliding roller 52 may also be fixed and the sliding plate 51 may also be reciprocated. Alternatively, the sliding plate 51 and the sliding roller 52 may also be moved in different directions relative to each other.

As described above, in the fixing device B in this embodiment, the sliding roller 52 does not rotate during the repairing of the surface of the parting layer 20c of the fixing roller 20. For this reason, the abrasion powder of the surface layer 52c of the sliding roller 52 and/or the parting layer 20c of the fixing roller 20 is easily accumulated in the sliding portion N4, so that the refreshing speed is high.

The surface roughness of the surface layer 52c of the sliding roller 52 is larger than a surface roughness of the parting layer 20c of the fixing roller 20 similarly as in Embodiment 1. Also in this embodiment, as the surface roughness, a three-dimensional arithmetic average roughness Sa (measured by “Micromap” manufactured by Ryoka Systems, Inc.) defined by ISO 25178 was used.

Also in this embodiment, similarly as in Embodiment 1, Sa of the surface layer 52c of the sliding roller 52 is 1.0 or more, and as the material for the surface layer 52c of the sliding roller 52, PFA was used. The roughened surface was formed by blasting, but a roughening method is not limited thereto. For example, the surface may also be roughed by sand blasting.

The control relating to the surface roughness refreshing for the sliding roller 52 will be described. In order to properly maintain the damage repairing speed of the surface of the parting layer 20c of the fixing roller 20, there is a need to estimate the durable lifetime of the sliding roller 52 such that the surface property of the surface layer 52c of the sliding roller 52 can be maintained to what extent.

As a method of estimating the durable lifetime of the sliding roller 52, i.e., it would be considered that a method of estimating the durable lifetime from a length of time in which the sliding roller and the fixing roller slide with each other and a method of estimating the durable lifetime from a total number of sheets passed through the nip are used, but any durable lifetime estimating method may also be used.

In this embodiment, the method of estimating the durable lifetime from the sliding time of the sliding roller 52 and the fixing roller 20 was used. That is, a method of estimating the durable lifetime in such a manner that the surface roughness Sa of the surface of the surface layer 52c of the sliding roller 52 becomes lower with a larger sliding time and thus the damage repairing speed for the surface of the parting layer 20c of the fixing roller 20 becomes slow was used. There is also a possibility that a relation of the repairing speed lowering with the sliding time changes depending on the structure of the fixing device, and therefore an actually measured value obtained by sliding the sliding roller 52 in an actual product structure of the fixing device may preferably be used.

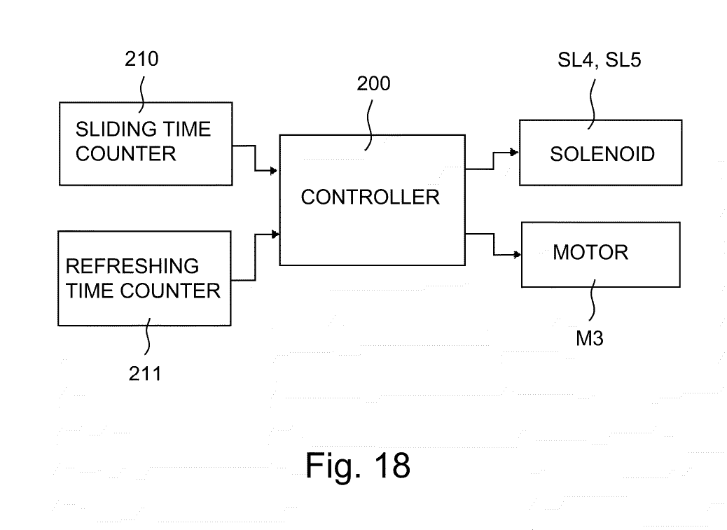

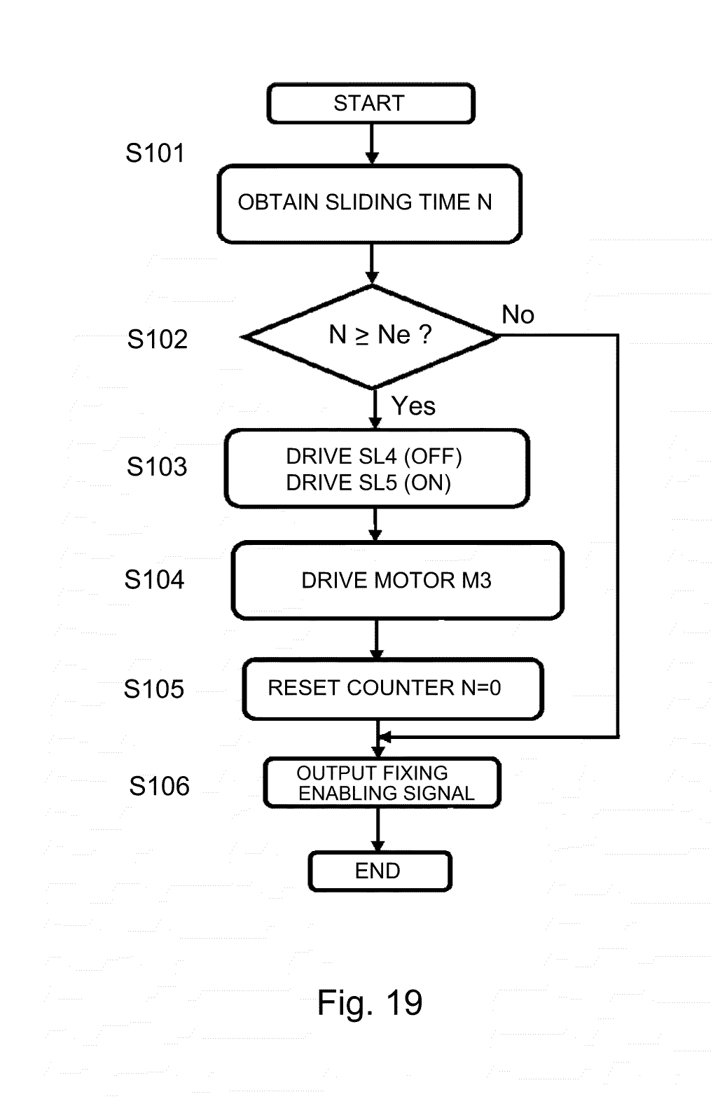

The surface roughness refreshing control in this embodiment realizes the refreshing of the surface roughness by contacting the sliding plate 51 and the sliding roller 52 each other and by rotating the sliding roller 52 for a predetermined time in the case where the sliding time of the sliding roller 52 is a certain value or more. FIG. 18 is a block diagram for illustrating a hardware constitution used for refreshing the surface roughness of the sliding roller 52. FIG. 19 is a flowchart for illustrating an operation of the surface roughness refreshing for the sliding roller 52.

When a print instruction (command) is inputted into the controller 200, a sequence goes to S101. In S101, a sliding time (sliding data) N integrated by a sliding time counter (integrating portion) 210 shown in FIG. 19 is obtained.

In S102, whether or not the sliding time N is a reference sliding time Ne or more is discriminated. When N is Ne or more (Yes), the sequence goes to S103, and when N is less than Ne (No), the sequence goes to S106.

As the reference sliding time Ne, a sliding time in which the damage repairing speed of the sliding roller 52 in the actual fixing device was lowered to 50% thereof was selected in advance and then was used. The sliding time N is a sliding time in which the surface layer 52c of the sliding roller 52 actually slides with the parting layer 20c of the fixing roller 20, and 0 is stored as a value thereof in a memory of the controller 200 when the fixing device is newly disposed. Further, separately, the value of the sliding time N may also be reset at an operating portion of the image forming apparatus by an operator and then may be inputted at the operating portion.

In S103, the solenoid SL4 is driven (turned off) and the solenoid SL5 is driven (turned on). As a result, the sliding roller 52 and the sliding plate 51 contact each other to form the sliding portion N5.

In S104, the motor M3 is driven. As a result, the sliding roller 52 is rotated, so that the surface of the surface layer 52c of the sliding roller 52 is roughened by the sliding plate 51 (start of the surface refreshing operation for the surface layer 52c).

In S105, a refreshing time counted by a refreshing time counter 211 is obtained, and then the drive of the motor M3 is stopped at the time when the refreshing time is 0 (end of the surface refreshing operation for the surface layer 52c).

That is, in S105, the sliding roller 52 is rotated for the refreshing time, and a rotation instruction (command) is sent from the controller 200 to the motor M3 so that the sliding roller 52 slides with the sliding plate 51, so that the refreshing operation is started. The refreshing operation is ended in such a manner that an end time is determined on the basis of a counter value of the refreshing time counter 211 and then the refreshing operation is ended after a lapse of a predetermined time. In this embodiment, a repairing time counter value was 60, so that the refreshing operation was performed for 1 minute. At the time of the end of the refreshing operation, the counter value is reset, and then 0 is stored in the memory. With respect to the refreshing time counter, separately, the operator may also be input the refreshing time.

In S106, a fixing enabling signal is outputted. The flowchart shown in FIG. 19 is based on the premise that the flowchart is used in the image forming apparatus, so that the flowchart is executed as a sub-routine flowchart during execution of printing. In this sub-routine flowchart, the fixing enabling signal (fixing enabling output) is outputted, so that an image forming operation itself is started or feeding of the recording material, for carrying thereon the toner image, to the nip N1 is started.

The fixing enabling signal is a signal used only in the controller 200, and a process thereof is carried out in various manners. For example, a certain specific variable can be converted into the fixing enabling signal or can be used for providing a flag for knowing the presence or absence of fixing permissions. From these variables or the flag, the fixing permission is discriminated, so that the image forming operation or the recording material feeding operation to the fixing device is started.

A printing durability test was conducted using the fixing device B in this embodiment and the fixing device in the comparison example and results were compared. The printing durability test was performed by continuously printing an image of a print ratio of 5%, and by setting Ne so that the refreshing operation was performed once every 150,000 sheets, and the fixing roller damage was checked every 1,000 sheets up to 10,000 sheets and every 10,000 sheets after 10,000 sheets. The fixing roller damage check was made by the presence or absence of the vertical stripe on a solid image formed on each of plain paper and glossy paper.

In the fixing device B in this embodiment, the surface roughness of the surface layer 52c of the sliding roller 52 is refreshed by the sliding plate 51. For that reason, the surface repairing effect for the surface of the surface layer 52c of the sliding roller 52 can be further maintained, and up to 500,000 sheets which is a durable lifetime of the fixing device B in this embodiment, a depth of the damage of the fixing roller can be suppressed, and even when the image is formed and fixed on the glossy paper on which the vertical stripe is easily visible, the image defect having a vertical stripe shape was not generated on the solid image until the end of the durable lifetime of the fixing device B.

In this embodiment, a constitution in which the sliding roller 52 is always slid with the fixing roller 20 also during the printing operation and thus the damage of the surface of the parting layer 20c of the fixing roller 20 is repaired may also be employed. Further, the present invention is not limited thereto, but may also use such an intermittent repairing method that before the damage generated on the surface of the fixing roller 20 by the feeding of the recording material influences the image, the fixing roller surface operation is appropriately performed every recording material feeding number depending on the species of the recording material. As a result, a degree of surface layer abrasion (wearing) of the sliding roller 52 is alleviated, so that it becomes possible to repair the fixing roller for a longer time.

### Other Embodiments

In the fixing devices B in Embodiment, a constitution in which a ceramic heater (heating portion) is disposed inside the core metal 21a of the pressing roller 21 and in which the surface of the pressing roller 21 is rubbed with the sliding sheet 27 of the sliding device 24 while heating the pressing roller 78 by the heater may also be employed. As a result, it is possible to repair the damage generated on the pressing roller surface.

Further, a constitution in which the surface of the fixing roller 20 is rubbed with the sliding sheet 27 of the sliding device 24 and in which the surface of the pressing roller 21 is rubbed with a sliding sheet 27 of another sliding device (not shown) having the same structure as that of the sliding device 24 may also be employed. As a result, it is possible to repair the damage generated on the fixing roller surface and the damage generated on the pressing roller surface. That is, a constitution in which at least one member of the fixing roller 20 and the pressing roller 21 is rubbed with the sliding sheet of the sliding device may be employed.

In the fixing device B in Embodiment 2, a constitution in which the sliding roller 52 of the sliding device 50 is slid with the surface of the pressing roller 21 may also be employed. As a result, it is possible to repair the damage generated on the pressing roller surface. Further, the sliding plate 51 may also be slid with the surface of the sliding roller 52. As a result, the surface roughness of the sliding roller 52 can be refreshed.

Further, a constitution in which the surface of the fixing roller 20 is rubbed with the sliding roller 52 of the sliding device 50 and in which the surface of the pressing roller 21 is rubbed with a sliding roller of another sliding device (not shown) having the same structure as that of the supplying device 50 may also be employed. As a result, it is possible to repair the damage generated on the fixing roller surface and the damage generated on the pressing roller surface. That is, a constitution in which at least one member of the fixing roller 20 and the pressing roller 21 is rubbed with the sliding sheet of the sliding device may be employed.

Further, a constitution in which the sliding plate 51 is slid with the surface of the sliding roller 52 in the fixing roller 20 side and in which the sliding plate is slid with the surface of the sliding roller in the pressing roller 21 side may also be employed. As a result, it is possible to refresh the surface roughness of each of the sliding rollers.

In Embodiments 1 and 2, as a contact-and-separation mechanism (means) for moving the pressing roller 21, the cleaning device 23 and the sliding devices 24 and 50 toward and away from the fixing roller 20, the solenoids are used. Further, as the contact-and-separation mechanism (means) for moving the sliding roller 52 toward and away from the fixing roller, the solenoids are used. However, these contact-and-separation mechanisms are not limited to the solenoids, but may also be a cam mechanism including a motor and a cam.

The image heating apparatus according to the present invention is not limited to use as the fixing devices B as in Embodiments 1 and 2. The image heating apparatus can also be effectively used as an apparatus (device) for modifying glossiness of an image (fixed image) once fixed on the recording material or a temporarily fixed image (partly fixed image).

While the invention has been described with reference to the structures disclosed herein, it is not confined to the details set forth and this application is intended to cover such modifications or changes as may come within the purpose of the lo improvements or the scope of the following claims.

This application claims the benefit of Japanese Patent Application No. 2014-076242 filed on Apr. 2, 2014, which is hereby incorporated by reference herein in its entirety.

What is claimed is:

1. An image heating apparatus comprising:
a rotatable member configured to heat a toner image on a recording material, wherein said rotatable member includes a parting layer at a surface thereof;
a heating portion configured to heat said rotatable member;
a slidable member slidable on said parting layer, wherein said slidable member includes a surface layer having a surface roughness larger than a surface roughness of said parting layer; and
a moving mechanism configured to move said slidable member relative to said rotatable member, which is in a rotating state, in a direction crossing with a rotational direction of said rotatable member so that a part of exfoliated matter of said parting layer and/or the surface layer is welded on said parting layer.

2. An image heating apparatus according to claim 1, wherein when a three-dimensional arithmetic average roughness is Sa, Sa of the surface layer is Sa1, and Sa of said parting layer is Sa2, the following relationship is satisfied:
Sa1>Sa2.

3. An image heating apparatus according to claim 1, wherein the surface layer is formed of a fluorine-containing resin material.

4. An image heating apparatus according to claim 1, further comprising a refreshing mechanism configured to refresh a surface roughness of the surface layer in contact with the surface layer.

5. An image heating apparatus according to claim 4, further comprising an integrating portion configured to integrate a time in which the surface layer slides with said parting layer,
wherein said refreshing mechanism performs a refreshing process depending on an output of said integrating portion.
